(19) United States
(12) Patent Application Publication
(10) Pub. No.: US 2025/0305236 A1
(43) Pub. Date: Oct. 2, 2025

(54) APPARATUS TOOL AND ATTACHMENT FOR EXCAVATOR FOR FORMING A DRAINAGE SYSTEM AND METHOD

(71) Applicant: Eric Richardson, Hurricane, WV (US)

(72) Inventor: Eric Richardson, Hurricane, WV (US)

(21) Appl. No.: 18/830,705

(22) Filed: Sep. 11, 2024

Related U.S. Application Data
(60) Provisional application No. 63/572,163, filed on Mar. 29, 2024.

(51) Int. Cl. E02D 17/20; E02D 17/18; E03F 5/04

(52) U.S. Cl. CPC E02D 17/20; E02D 17/18; E03F 5/04

(57) ABSTRACT

An apparatus, system, and/or method for forming a drainage system. The apparatus comprises a linearly elongated handle depending from a linearly elongated body used for forming a channel through tamping. The system and/or method for forming such a system includes tamping means having a head with a handle upwardly depending therefrom and utilized for forming a channel in the ground. A quantity of construction aggregate is placed in the channel. A hemicylindrical conduit is installed superjacent the construction aggregate via mechanical fasteners. The apparatus may be controlled manually or inserted as an attachment to excavating machinery.

### I. RELATED APPLICATIONS

This application claims the benefit of U.S. Provisional Application No. 63/572,316, filed on Mar. 31, 2024.

### II. FIELD OF THE INVENTION

The present application discloses and describes an apparatus, system and method for installing a drainage system, and in particular, discloses and describes an apparatus tool and apparatus attachment for an excavator or similar machine, the tool and/or attachment utilized in forming a system and/or method for creating a channel and installing aggregate and conduit for dispersing water to an appropriate drainage outlet.

### III. BACKGROUND OF THE INVENTION

Numerous attempts have been made to provide improved drainage systems and the tools utilized to create such drainage systems.

Tamping tools and other means for forming channels or ditches for draining fluid, especially water, have been introduced to more efficiently install such systems. Many of the tamping tools are manually manipulated. Most such tools have a substantially flat and square or rectangular form. The use of such tools may be effective, however, the manual labor required to form the channels or ditches desired increase the likelihood of inury, require many hours of input, and often yield less than desirable outcomes.

Accordingly, a new or improved manner for providing such tools and for forming such drainage systems is desired.

### IV. SUMMARY OF THE INVENTION

In one embodment, a drainage system comprises tamping means comprising a head with a handle upwardly depending from the head, tamping means for forming a channel in the ground. The system includes a quantity of construction aggregate installed in the channel formed from using tamping means. The system further includes a hemicylindrical conduit installed superjacent the construction aggregate, the conduit comprising a first end and a second end, wherein the first end comprises a first aperture formed adjacent the first end and the second end comprises a second aperture formed adjacent the second end, the first aperture receiving a first mechanical fastener and the second aperture receiving a second mechanical fastener, the first mechanical fastener and the second mechanical fastener securing the hemicyclindrical conduit superjacent to the construction material.

In another embodiment, a drainage system comprises tamping means comprising a head with a handle upwardly depending from the head, tamping means for forming a channel in the ground, wherein tamping means is attachable and removable from construction machinery. The system includes a quantity of construction aggregate installed in the channel formed from using tamping means. The system further includes hemicylindrical conduit installed superjacent the construction aggregate, the conduit comprising a first end and a second end, wherein the first end comprises a first aperture formed adjacent the first end and the second end comprises a second aperture formed adjacent the second end, the first aperture receiving a first mechanical fastener and the second aperture receiving a second mechanical fastener, the first mechanical fastener and the second mechanical fastener securing the hemicyclindrical conduit superjacent to the construction material.

Each of the aforementioned embodiments includes the handle of tamping means comprising a lower handle and an upper handle, the lower handle intermediately disposed between the head and the upper handle. The head comprises a cylindrical body that includes a hollow interior cavity. The head also comprises at least one removable end cap The interior cavity receives a volume of material providing ballast and energy absorption to the head, wherein the volume of material comprises solid and/or fluid material.

Each of the aforementioned embodiments includes the head comprising a cylindrical body having a hemicylindrical form consistent with the hemicylindrical conduit. It is further envisioned that the cylindrical body further comprises a pair of wings disposed perpendicular to the lower handle, the pair of wings mutually opposed.

In another embodiment, a removable tool for construction equipment is envisoned, the tool adapted for use in forming a channel for constructing a drainage system, the tool comprising tamping means, wherein tamping means comprises a linearly elongated body comprising a cylindrical form, the body comprising a hollow interior cavity and a cap for enclosing the cavity, wherein the cavity receives a volume of material providing ballast and energy absorption to the body. The tool also includes a linearly elongated handle depending from the body, the handle having a lower handle and an upper handle, the lower handle intermediately disposed between the head and the upper handle. Wherein the body further comprises a pair of wings disposed perpendicular to the lower handle, the pair of wings mutually opposed.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a general illustration of land having standing surface water and the multiple layers of humus, soil, and fragments/rocks beneath the humus;

FIG. 2 is a perspective illustration of construction equipment or machinery (M) with a tamping device as an attachment to the end of the arm at the end of the boom of the machine (M);

FIG. 3 depicts the drainage system described herein utilized to form a channel to relieve the standing water from the ground surface;

FIG. 4a and FIG. 4b depict embodiments of a tamper device, including a tamping device with a solid body (FIG. 4a) and a tamping device with a hollow body and at least one end cap (FIG. 4b);

FIG. 4c depicts an alternative embodiment of the tamper device in FIG. 4a and FIG. 4b, wherein the body has a hemicylindrical form;

FIG. 4d depicts an alternative embodiment of the tamper device having a pair of wings depending from the body of the device;

FIG. 5 depicts a length of hemicylindrical conduit;

FIG. 6a depicts a single length of hemicylindrical conduit for addressing runoff; and,

FIG. 6b depicts a pair of hemicylindrical conduit arranged in a vertically stacked manner for addressing significant runoff.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

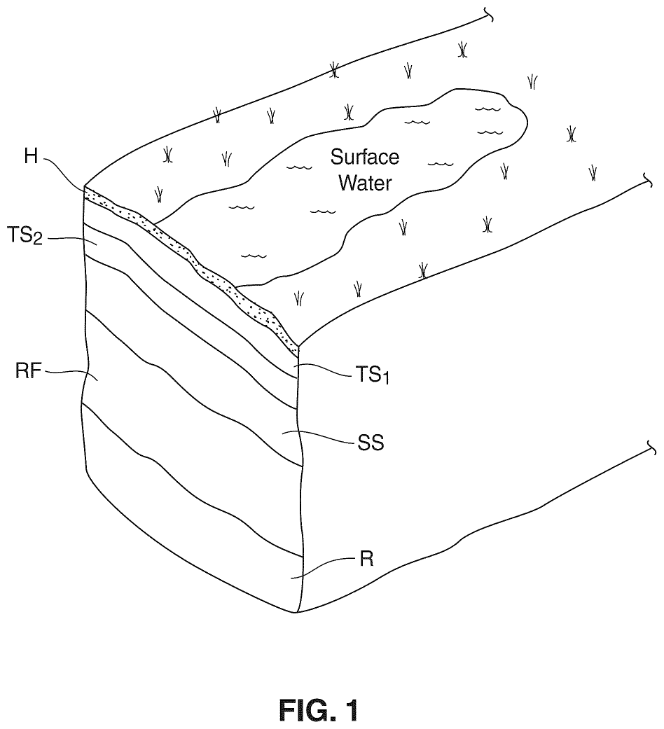

FIG. 1 discloses an area of land with standing surface water. The land is depicted in partial sectional perspective, with a humus (H) layer immediately subjacent the visible vegetation on the surface (e.g., grass, weeds, etc.). Immediately below the humus (H) layer are a first top soil layer (TS1) and a second top soil layer (TS2). Below the top soil layers (TS1+TS2) is a subsoil layer (SS). Below the subsoil layer (SS) are rock fragments (RF) and rock (R) layers. It is envisioned that the channel 120 formed consistent with the system(s) and/or method(s) below may be formed to a depth between the first top soil layer (TS1) and down to and including the subsoil (SS) layer, and variable depths therebetween.

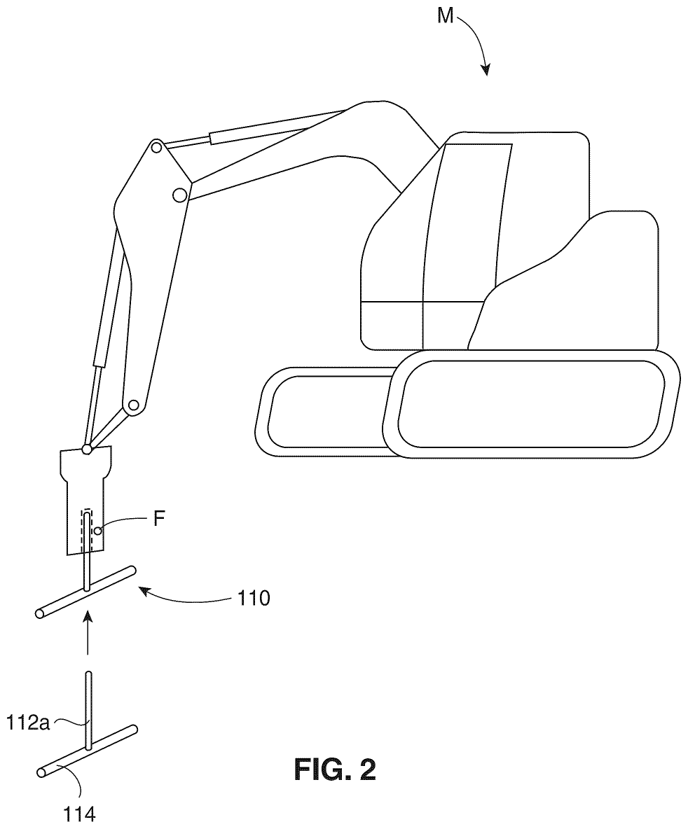

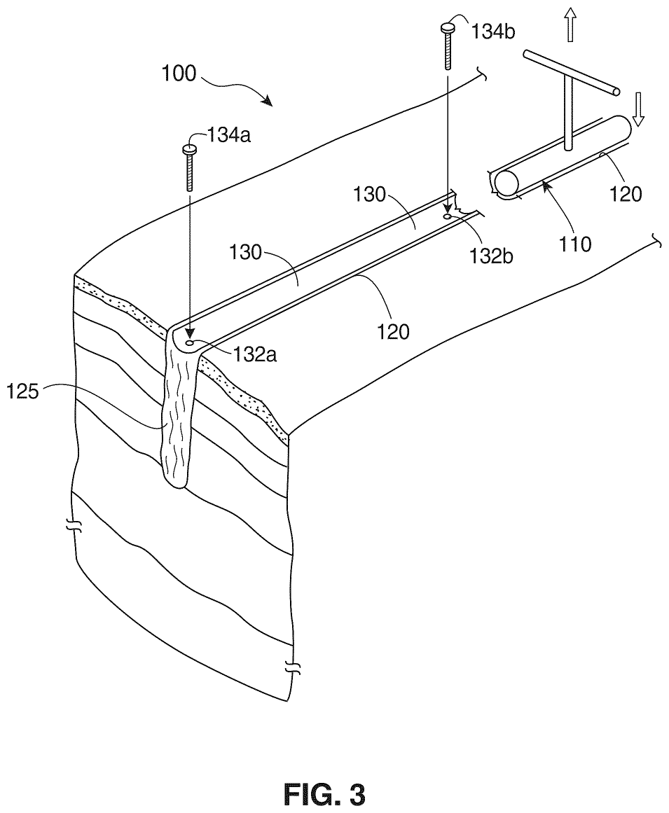

According to at least one embodiment, and consistent with FIG. 2 and FIG. 3, a drainage system and/or method for distributing surface water is generally denoted by the reference character 100. The system and/or method 100 comprises the utilization of a tamping apparatus 110 used to form a channel 120 in the surface material (e.g., grass covered ground). Upon formation of channel 120 at an appropriate depth and of an appropriate length, a layer of construction aggregate 125 material is disposed within the channel 120. Thereafter, hemicylindrical conduit 130 is disposed superjacent the aggregate 125 material, installed via one or more mechanical fasteners 134a/134b inserted through one or more apertures 132a/132b.

In one particular embodiment, and consistent with FIG. 2, the tamping apparatus 110 is an attachment at the end of a construction vehicle, such as an excavator, mini-excavator, skid steer, or other construction machinery, equipment, or vehicle, generally denoted by the reference character “M”. In one embodiment, the tamping apparatus 110 as an attachment may be a separate attachment that is attachable and removable from the arm (at the end of the boom) via a link or linkage. In another embodiment, the tamping apparatus 110 is a linearly elongated lower handle 112a and a head 114, wherein the lower handle 112a is inserted into and secured within a cavity formed in the attachment area. The lower handle 112a may be inserted and secured within the cavity via various friction fit mechanisms, including tightening of mechanical fasteners F, inflation of bladders, the use of returnably resilient material(s), and other similar mechanisms for retaining the lower handle 112a therein. In another embodiment, the attachment comprises a tool for digging or removing material to form the channel 120. It is envisioned that the construction equipment/machinery (M) arm and attachment(s) may be actuated through hydraulics, pneumatics, and/or similar mechanisms.

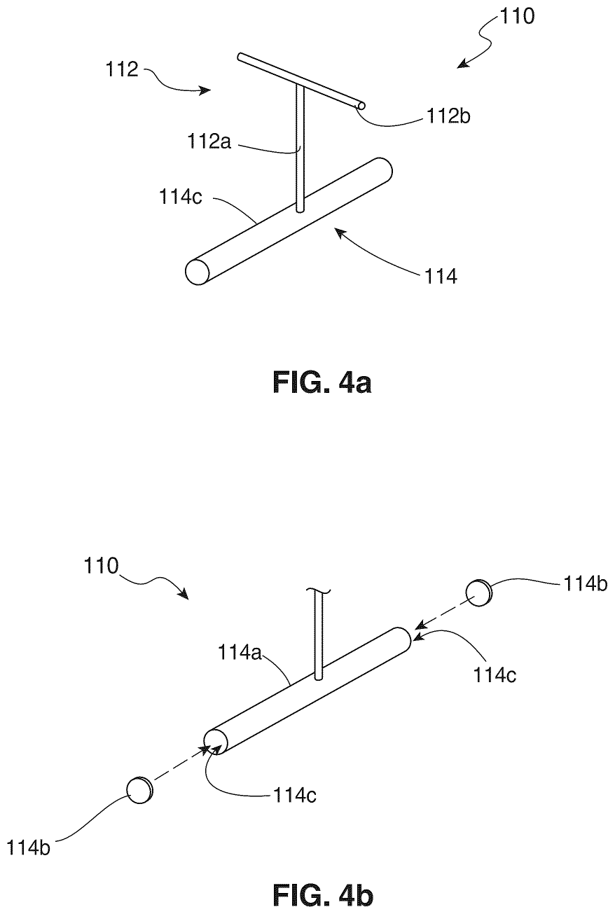

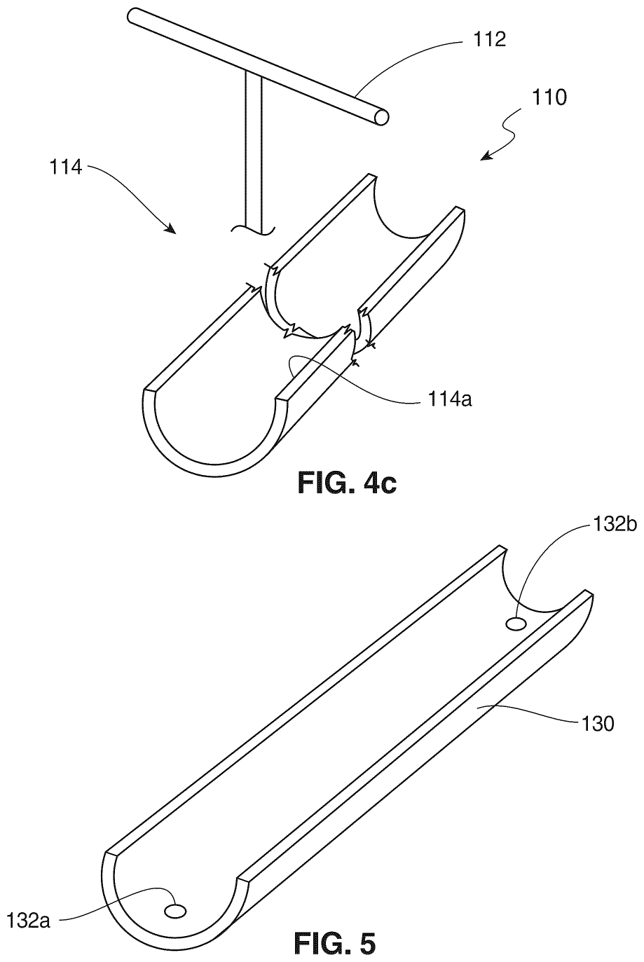

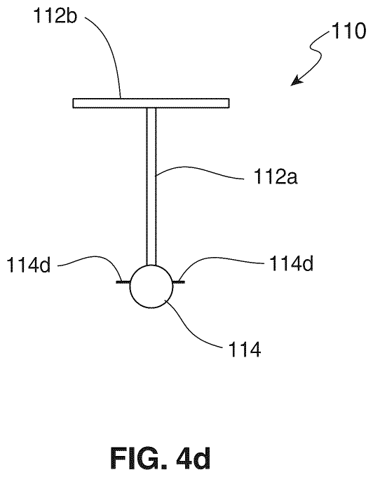

Consistent with FIG. 2 and FIG. 3, the tamping apparatus 110 comprises a handle 112. The handle 112 comprises a lower handle 112a intermediately disposed between the head 114 and the upper handle 112b. In a preferred embodiment, consistent with FIGS. 4a through 4c, the upper handle 112b and the head 114 are formed and disposed so that a vertical plane oriented through the upper handle 112b and a separate vertical plane oriented through the head 114 are disposed or formed at right angles relative to the other. Disposing or orienting the upper handle 112b at a right angle relative to the head 114 provides significant leverage to the user. This orientation improves the user's ability to more quickly form the desired channel 120, with the force generated through raising and lowering the upper handle 112b more optimally distributing the forces through the lower handle 112a and into the head 114. Moreover, this orientation allows the user to better align him/herself relative to the intended line of the channel 120 and allowing the user to generate greater forces than if having to side-stand the intended line of the channel 120.

In one embodiment, consistent with FIGS. 4a and 4b, the head 114 comprises a cylindrical body 114a. In one such embodiment (FIG. 4a), the body is solid. In another embodiment (FIG. 4b), the body 114a comprises a hollow or empty interior cavity 114c therein and enclosed by one or more removable end caps 114b. The interior cavity 114c may be filled with a variety of materials, including solids and/or fluids, and combinations thereof, including water, sand, grain, rice, or other solid material capable of providing both ballast and energy absorption as the head 114 strikes ground or ground-related materials for channel 120 formation.

The head 114 having a hollow interior cavity 114c further allows the user to introduce additional ballast so that some of the strike force is increased. By utilizing ballast (e.g., sand), the user also provides a means to more evenly distribute the generated forces throughout the head 114. Moreover, the ballast (e.g., sand) inhibits painful and/or sometimes injurious redirection of the generated forces, which can often be redistributed back up and through the lower handle 112a and into the upper handle 112b. Redirected energy yielding reverberation or other similar forces are not only painful but can inflict damage that can accumulate into injury as well as shortening the lifespan of the tamper 110 and/or elements of the tamper 110.

In another embodiment, consistent with FIG. 4c, the body 114a comprises a hemicylindrical form similar to that of the conduit 130 described below. Via this hemicylindrical form, the body 114a is used to form the channel 120 in the ground. Because of the open-face in the body 114a and the hemicylindrical shape accommodating insertion of or placement of ballast thereon and therein, similar forms of ballast may be introduced for generating additional forces and also distributing those forces in a manner that reduce injury and/or damage. It is envisioned that such ballast for this embodiment would preferably be available in a closed container (e.g., bag or sack) to prevent the elements of the ballast from being distributed in a wasteful and/or messy manner.

In another embodiment, consistent with FIG. 4d, the body 114a comprises a hemicylindrical form and includes a pair of wings 114d. The wings 114d depend from the body 114a. In particular, the wings 114d depend from the body 114a with an orientation substantially parallel to the orientation of the upper handle 112b or substantially parallel to the orientation of the ground or surface in the absence of upper handle 112b. Additionally, the wings 114d have an orientation approximately perpendicular to the lower handle 112a. The wings 114d function as a physical and visual limit on the depth at which the body 114a displaces soil or other ground material.

It is additionally envisioned that the tamping apparatus 110 may comprise a self-propelling mechanism (e.g., motor and wheel pulley(s)) that includes a platform that allows a user to stand upon the platform during movement of the apparatus 110. Moreover, whether separate or in combination with the platform, or in combination with another feature disclosed herein, the tamping apparatus 110 may comprise a vibratory element for imparting compaction. Moreover, in another embodiment, the body 114a with hemicylindrical form and pair of wings 114d may used in combination with or as part of a vibratory compactor.

Depending upon the drainage problem, including visible standing surface water, the channel 120 length and depth may be variable to address each specific situation. Usually, the channel 120 depth will measure between three inches and up to twelve inches. In particular, it is envisioned that most installations will require a minimum depth of four inches and a maximum depth of eight inches. Ideally, most installations will require a depth of approximately five inches to six inches. The length of the channel 120 will mostly depend upon the length/distance of any standing water and/or dampness of the surface.

A variety of construction aggregate 125 material(s) may be used. Construction aggregate 125 may comprise sand, gravel, crushed stone, slag, recycled concrete, and/or geosynthetic aggregates, and combinations of these materials. Geosynthetic aggregates may include a variety of polymers including but not limited to high density polyethylene (HDPE), polypropylene (PP) and polyester (PET). Such polymers are highly resistant to biological and chemical degradation. Regardless of composition, the construction aggregate 125 promotes stabilization, reinforcement, drainage, and/or filtration.

It is also envisioned that additional attachments may be provided. For example, a hydraulic-driven rotational trenching attachment may be provided to navigate difficult terrain. Alternatively, a hydraulic-driven rotational digging attachment may be provided. Other similar attachments are envisioned.

Consistent with FIG. 5, the hemicylindrical conduit 130 is formed and utilized as means for promoting drainage through the construction aggregate 125 disposed below the conduit 130. The conduit 130 is formed in a hemicylindrical shape by dividing a length of cylindrical conduit into halves along the entirety of its length. Shaping or forming the conduit 130 may be achieved through cutting or other similar means, or alternatively, may be formed through fabrication and/or molds that define this general shape.

The hemicylindrical conduit 130 comprises a first aperture 132a and a second aperture 132b, wherein the apertures 132a, 132b are adjacent the respective terminal ends of the length of the conduit 130. As depicted in FIG. 3, a heavy mechanical fastener 134a is disposed within the first aperture 132a and a separate heavy mechanical fastener 134b is disposed with the second aperture 132a. The heavy mechanical fasteners 134a, 134b secure the conduit 130 within the formed channel 120 by compressing the installed construction aggregate 125 material between the conduit 130 and the sub-channel material 136 subjacent to the basin comprising the formed channel 120.

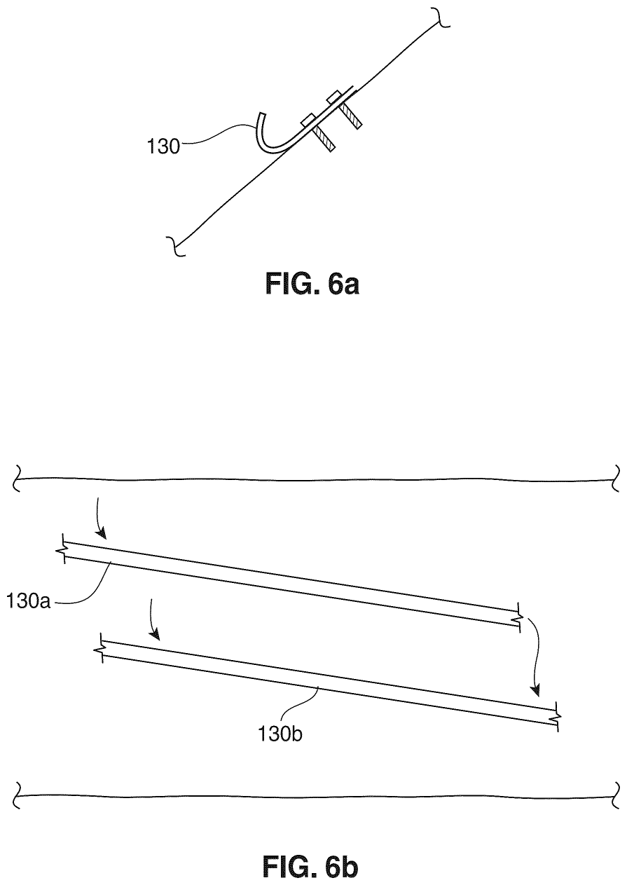

A method for contending with excess water runoff for sloped terrain is disclosed in FIG. 6a and FIG. 6b. In FIG. 6a, a single length of hemicylindrical conduit 130 is installed into the terrain using bolts. The conduit 130 slows the rate of runoff water flow. Moreover, the conduit 130 prevents the oversaturation of runoff water into a specific area and distributes the water more slowly to accommodate and prevent build-up.

In FIG. 6b, two lengths of conduit 130A and 130B are installed at angles and in an overlapping manner. This particular methodology is to protect particularly significant sloping terrains. The first conduit 130A is installed near the apex of the slope and at an angle to distribute the overflow of water downstream. Any overflow via the sides or through the end of the first conduit 130A is funneled into the second conduit 130B, whereby the ultimate distribution of the overflow water is some distance from its natural aggregating point in the absence of the conduit(s) 130A and/or 130B. Multiple conduit units may be installed should the length and/or height of the terrain demand such measures.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A drainage system comprising:
tamping means comprising a head with a handle upwardly depending from the head, tamping means for forming a channel in the ground;
a quantity of construction aggregate installed in the channel formed from using tamping means; and,
hemicylindrical conduit installed superjacent the construction aggregate, the conduit comprising a first end and a second end, wherein the first end comprises a first aperture formed adjacent the first end and the second end comprises a second aperture formed adjacent the second end, the first aperture receiving a first mechanical fastener and the second aperture receiving a second mechanical fastener, the first mechanical fastener and the second mechanical fastener securing the hemicyclindrical conduit superjacent to the construction material.

2. The system of claim 1, wherein the handle of tamping means comprises a lower handle and an upper handle, the lower handle intermediately disposed between the head and the upper handle.

3. The system of claim 2, wherein the head comprises a cylindrical body.

4. The system of claim 3, wherein the cylindrical body comprises a hollow interior cavity.

5. The system of claim 4, wherein the interior cavity receives a volume of material providing ballast and energy absorption to the head.

6. The system of claim 5, wherein the volume of material comprises solid and/or fluid material.

7. The system of claim 2, wherein the head comprises at least one removable end cap.

8. The system of claim 1, wherein the head comprises a cylindrical body having a hemicylindrical form consistent with the hemicylindrical conduit.

9. The system of claim 8, wherein the cylindrical body further comprises a pair of wings disposed perpendicular to the lower handle, the pair of wings mutually opposed.

10. A drainage system comprising:
tamping means comprising a head with a handle upwardly depending from the head, tamping means for forming a channel in the ground, wherein tamping means is attachable and removable from construction machinery;
a quantity of construction aggregate installed in the channel formed from using tamping means; and,
hemicylindrical conduit installed superjacent the construction aggregate, the conduit comprising a first end and a second end, wherein the first end comprises a first aperture formed adjacent the first end and the second end comprises a second aperture formed adjacent the second end, the first aperture receiving a first mechanical fastener and the second aperture receiving a second mechanical fastener, the first mechanical fastener and the second mechanical fastener securing the hemicyclindrical conduit superjacent to the construction material.

11. The system of claim 10, wherein the handle of tamping means comprises a lower handle and an upper handle, the lower handle intermediately disposed between the head and the upper handle.

12. The system of claim 11, wherein the head comprises a cylindrical body.

13. The system of claim 12, wherein the cylindrical body comprises a hollow interior cavity.

14. The system of claim 13, wherein the interior cavity receives a volume of material providing ballast and energy absorption to the head.

15. The system of claim 14, wherein the volume of material comprises solid and/or fluid material.

16. The system of claim 10, wherein the head comprises at least one removable end cap.

17. The system of claim 10, wherein the head comprises a cylindrical body having a hemicylindrical form consistent with the hemicylindrical conduit.

18. The system of claim 17, wherein the cylindrical body further comprises a pair of wings disposed perpendicular to the lower handle, the pair of wings mutually opposed.

19. A removable tool for construction equipment, the tool adapted for use in forming a channel for constructing a drainage system, the tool comprising:
tamping means, wherein tamping means comprises:
a linearly elongated body comprising a cylindrical form, the body comprising a hollow interior cavity and a cap for enclosing the cavity, wherein the cavity receives a volume of material providing ballast and energy absorption to the body; and,
a linearly elongated handle depending from the body, the handle having a lower handle and an upper handle, the lower handle intermediately disposed between the head and the upper handle.

20. The tool of claim 19, wherein the body further comprises a pair of wings disposed perpendicular to the lower handle, the pair of wings mutually opposed.
